(19) United States
(12) Patent Application Publication
(10) Pub. No.: US 2001/0048692 A1
(43) Pub. Date: Dec. 6, 2001

(54) Method for network medium access control

(76) Inventor: Bernd Karner, Muchen (DE)

Correspondence Address: Dorsey & Whitney LLP, Pillsbury Center South, 220 South Sixth Street, Minneapolis, MN, 55402-1498, US

(21) Appl. No.: 09/827,556

(22) Filed: Apr. 6, 2001

(30) Foreign Application Priority Data
Apr. 10, 2000 (DE) 100 17 747.6

(51) Int. Cl. H04B 7/212

(52) U.S. Cl. 370/442; 370/444

(57) ABSTRACT

The invention relates to a method for medium access control by transmission units (2) for data transmission over a network (1), wherein data from a transmission unit (2) can be transmitted over the network within cyclical time slots. The method is particularly suited as a control protocol in a local powerline network within a building. It is proposed that access to a non-occupied time slot (8) by a plurality of transmission units (2) is controlled in that one of said transmission units (2) wins the corresponding time slot (9) of the next cycle based on comparing priority values. Each priority value is determined by the type, the amount and/or a time delay of the data to be transmitted, and the corresponding time slot of the following cycle is reserved for data transmission by said winning transmission unit (2).

### DESCRIPTION

The present invention relates to a method for controlling multiple accesses by transmission units to a network for data transmission, wherein the data can be transmitted by a transmission unit according to a time division multiplex scheme within certain time slots which are cyclically arranged. The method is intended as a medium access control protocol in a local network on the powerlines e.g. in a building.

Data are typically transmitted on powerlines by terminals having transmission units using modems for orthogonal frequency division multiplexing (CFDM) in certain admissible frequency bands. But the powerlines were ordinarily not designed for data transmission and the particular characteristics of a power line have thus to be taken into account. In particular, characteristics of the transmission medium change depending on the location in the network, on the transmission frequency and on time. Further, noise and jam are abundant. And low impedance loads attenuate the data signals.

Methods for power line data transmission are disclosed, for example, in DE-A-199 00 324 and 199 33 535.

There are no standards yet for interconnecting OFDM modems via power line with an appropriate access control protocol and not even proposals for such standards are known. The protocol must integrate various services such as pure data communication (e-mail, internet or file transfer), device control (e.g. ON, OFF or other control processes for devices) and real time applications (e.g. telephone). It has to guarantee the requirements for tire latency, data rate and error rate (service quality) of these services. And it is required to be sufficiently robust against the typical noise occurring on the power line.

Although an access protocol which is particularly suited for powerline communication was not yet proposed, access control protocols for other media are known:

Standard Ethernet is based on carrier sense multiple access with collision detect (CSMA/CD) with a collision resolution algorithm known as BEB (Binary Exponential Backoff).

A modification of this technique which assigns different priorities to different transmission units is disclosed in WO 99/43130. This document proposes that a transmission unit which has recognized from the absence of a carrier signal that the channel has become available waits for a certain amount of time before commencing transmission. The waiting time depends on the priority of the transmission unit. The use of a known tree algorithm is proposed to resolve collisions between units having used he same waiting time. The waiting time is measured as a multiple of a unit time called a time slot. Otherwise, data transmission is not bound to time slots.

A CSMA/CD method wherein short messages are allowed to gain priority over longer messages is disclosed in DE-A-3930316.

DE-A-4343704 discloses a carrier sensing medium access protocol with collision avoidance (CSMA/CA) where different terminals have different waiting times until they are allowed to transmit after the channel has become available.

Another media access control protocol based on priorities is disclosed in DE-A-3736408.

Collision resolving methods in time division multiple access systems (TDMA) are disclosed in DE-A-4314790 and EP-A-755137.Further collision resolving strategies are disclosed in EP-A-833479, DE-A-19752697 and U.S. Pat. No. 5,953,344.

It is an object of the invention to provide a method for controlling multiple access by transmission units to a network which is particularly suited for a local cower line network.

This object is solved by the methods of claims 1, 12 or 13. The subclaims are directed to preferred embodiments of the invention.

The invention preferably uses time division multiplexing with a plurality of time slots which are cyclically repeated. If used on a powerline, this has the following advantage. To cope with low channel impedance on the powerline, the transmission units are typically couple to the powerline with low output impedance. This makes it difficult for a plurality of them to transmit simultaneously. But when the channel capacity is distributed among them in the time domain by time division multiple access (TDMA), parallel transmissions do not interfere. Different transmission units access different time slots for data transmission.

Data to be transmitted are initially assigned a priority value based on the type of service and/or the amount of data to be transmitted and/or the time delay a transmission unit has waited already with the data ready to transmit when it recognises an available time slot. If two or more transmission units access the same time slot for data transmission in one cycle, a contention process is invoked in which the priority values are compared within the corresponding time slot of the following cycle. That transmission unit whose data have the highest transmission priority as determined by its priority value wins the contention process on the channel and can transmit data in the corresponding time slot of further following cycles. Thus, the connection leads to a reservation of a time slot for one transmission unit which transmits in the same time slot of the following cycles (advance reservation) whereas no other transmission unit is allowed to access that time slot.

The reservation of a time slot can be indicated by a reservation signal, e.g. by a subcarrier or by means of a suitable synchronization or correlation signal by the winning transmission unit. If a terminal does not recocgnise a reservation signal within a certain time slot, the time slot is assumed to be available and the contention process for that time slot can be performed in the next cycle. Preferably, the last transmission on a reserved time slot by a transmission unit expressly frees the time slot by e.g. omitting the reservation signal so that other transmission unit can make their first access to that time slot already during the next cycle.

For determining the priority values, the data to be transmitted can be allocated to three groups in accordance with their type:

Switch or control signals include a small amount of data only so that their time duration of having a channel seized is not particularly critical for other services. But switch signals require quick access to a channel because delays in switching of devices cannot be accepted Switch signals will therefore receive priority over all other signals.

Real time connections (e.g. for telephone services) tolerate higher error rates during data transmission but require a sufficiently high data rate and small latency time. And the connection must be able to access the reserved time slot for a time period of arbitrary length.

Pure data transfer services allow higher latency times and thus have the lowest priority for channel access. But the data rate must be sufficiently high and the error rate virtually zero. Hence, the time while a time slot remains occupied by a data transfer service is limited to a certain number of cycles so that other transmission units are given the opportunity of channel access if the total channel is entirely busy and other time slots unavailable. However, if the latter condition is not fulfilled and another time slot is available, it is unnecessary to free a time slot seized by a data transfer service.

Apart from the type of data transmission, the property value determination can make distinctions bases on the wait time of a transmission unit and on the amount of data to be transmitted.

The aforesaid criteria allow to determine a priority value P as e.g. a bit pattern with the most significant bit set when a switch signal is to be transmitted and a next lower significant bit set to indicate a real time connection. Further bits encode the wait time of data ready to transmit in a transmission unit and/or the number of data packets collected in a transmission buffer of the transmission unit.

The selection of a winning transmission unit during the contention process can be carried out based on the priority values without requiring a central controller. Each transmission unit can check itself whether another unit transmits on a channel and whether the other unit has a higher priority and wins the contention process.

Variable data amounts may make it desirable to reserve more than one time slot for data transmission by one transmission unit. This is achieved by defining a value (WS) indicating the wait time of the transmission unit with data ready to transmit and/or the amount or data to be transmitted, e.g. the number of data packets in a transmission buffer, wherein the transmission unit can attempt to reserve further free time slots during its data transmission as long as the value WS exceeds a predetermined upper threshold WSₘₐₓ. The transmission unit can then win again a contention process on the channel and can reserve further time slots. When the value WS falls below a predetermined lower threshold WSₘᵢₙ, an additional time slot is freed again.

This dynamic time slot allocation and reallocation could also be implemented independently from the channel access control protocol of e.g. claim 1.

There may occur the case that even after the contention process, two transmission units access the same time slot because both believe erroneously to have won the contention or are unaware of each other due to a specific network topology, known as the “hidden terminal” problem. This results in transmission errors which are recognises by an error recognition technique such as a parity check. If a predetermined number of errors per time or per number of cycles are recognised, the respective time slot is freed and the two transmission units affected by the transmission errors attempt reservation of a time slot anew each after a random delay. The delay should be longer than the duration of one time slot. This ensures that the new channel access will not immediately lead again to a collision.

This way of resolving collisions could also be incremented independently from the channel access control protocol of, e.g., claim 1.

Some aspects of the method are summarized in the following:

The channel capacity is reserved in advance, whereby data packet repetitions, which would otherwise be necessary upon a collision, can be avoided. The quality of service can be guaranteed by assignment of priority values and by controlling the time for which a slot remains reserved for a service.

Further, the desired service quality and a fair distribution of the channel capacity to the services car be achieved by setting the priority values used for resolving collisions during channel access, under consideration of the wait time and data amount of a user terminal.

A decentralized dynamic selection and deselection of slots based on threshold values for the number of data packets in a transmit buffer or the wait tire of a user terminal is provided. This makes the system robust against noise, interference and failure of parts of the network or of individual user terminals.

A preferred embodiment of the invention will now be explained with reference to the drawings.

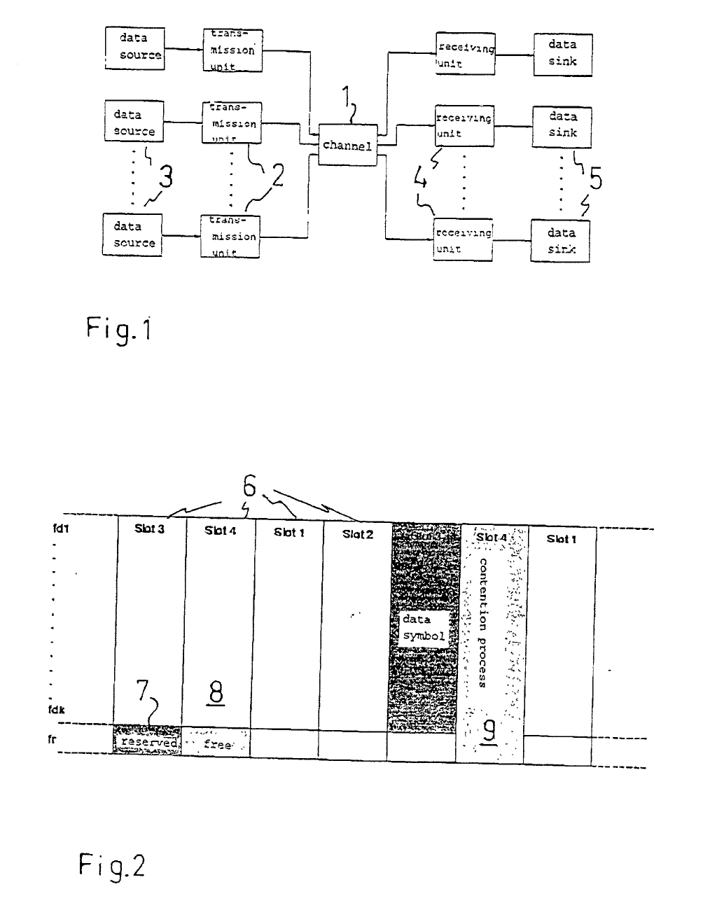

FIG. 1 shows a network for data transmission from plural transmission units to plural receiving units via a channel, and

FIG. 2 shows a schematic representation of cyclically arranged time slots and their reservation by the present embodiment.

A channel 1 as shown in FIG. 1 is formed by a power line network within a flat or building Coupler to the channel are transmission units 2 and receiving units 4 each formed by OFDM modems. These are connected to a respective data source 3 or data sink 5. The data sources 3 and data sinks 5 can be telephones for a real time service, switches for lighting, heating or other appliances which are supplied with switch signals, and other equipment and computers which participate in data transfer services such as e-mail or file transfer. A data source 3 with a transmission unit 2, or a data sink 5 with a receiving unit 4 form a terminal to the network.

In Europe, the OFDM modems must presently comply with CENELEC standard EN50065. They operate with OFDM symbols of a duration of e.g. 5 ms each and transmit in CENELEC frequency bands B (95 to 125 kHz) and D (140 to 148.5 kHz). The data transmission rate is about 150 kbit/s when 64-QAM encoding (quadrature amplitude modulation) is used.

The transmission units 2 must access the channel 1 to transmit data originating from the data sources 3. The present multiple access method serves as a protocol to allow the common use of the powerline by a plurality of simultaneous transmissions.

As shown in FIG. 2, transmission occurs within four TDMA time slots 6 called “Slot 1” to “Slot 4”, each 10 ms long. One time slot 6 thus allows transmission of two OFDM symbols.

The present embodiment uses priority values P each having a bit pattern with the most significant bit set to indicate a switch signal or the second most significant bit set to indicate a real time service or the following bits set to encode the number of data packets in a transmic buffer of the transmission unit 2, as originating form file transfer, e-mail or internet access. Each priority value P is determined by the receive transmission unit 2 itself, depending on the data to be transmitted. Transmission units 2 which access a non-occupied (non-reserved) time slot 8 (“Slot 4” in the example of FIG. 2) enter a contention process in the same time slot 9 (“Slot 4”) of the following cycle wherein they broadcast their priority values, each recognises whether it has the highest priority value and the one with the highest priority wins. The corresponding time slot (“Slot 4”) on channel 1 is then reserved for the winning transmission unit during the following cycles. The reservation in advance is indicated by a reservation signal 7 from the winning transmission unit until its omission in time slot 8 tells waiting transmission units 2 that they have an opportunity for a first access to the channel 1 in the corresponding tire slot of the following cycle.

Since the priority values of the contending transmission units constitute a limited amount of information, they can all be transmitted and received within one time slot by e.g. using different subcarrier for each transmission unit which broadcasts a priority value or by using different sub time slots.

According to the present embodiment, the delay or latency time for real time transmission is smaller than 4×10 ms=40 ms, if a free time slot is available. Real time services can rake an advance reservation without time limitation. Data transfer services are only allowed in this embodiment to occupy a time slot for at most 20 cycles if also all other TDMA time slots are occupied. When a switch signal of highest priority replaces a data transfer service in a time slot, the maximum delay for channel access by a switch signal is thus 21×4×10 ms=840 ms. This is the maximum, time until the time slot can be seized through the contention process.

The OFDM subcarriers are designated by fa1 . . . fdk and fr in FIG. 2. Subcarrier fr is used for transmission of the reservation signal 7 by he transmission unit 2 having reserved a time slot 6.

In summary, the present embodiment has the following features and advantages:

It provides a multiple access control method MAC protocol) for a local network e.g. a power line network based on a time division multiple access technology with a constant number of time slots in each cycle. The transmission units 2 in the user terminals of the network can occupy one or more free time slots.

Several user terminals can perform a convention process for one time slot. The contention process is a collision resolving method. Each user terminal calculates a priority value from the type of data to be transmitted (switch signals are given priority over real time services and these have priority over data transfer services), the amount of data to be transmitted and/or the wait time of the data to be transmitted.

The contention is won by the terminal having the highest priority, whereby the collision is resolved.

The winner of the contention process reserves the respective time slot in the following cycle an, can further reserve it for a certain number of following TDMA cycles. This number depends on the priority (i.e. the type) of data transmission.

Each, terminal determines from a value W obtained from the wait time and/or data amount to be transferred in relation to an upper threshold Wₘₐₓ and a lower threshold Wₘᵢₙ whether to attempt occupation of a further ti.,e slot (if W>Wₘₐₓ) or to release a time slot (if W<Wₘᵢₙ).

Data transmission is interrupted if a collision occurs in spite of the above collision resolving method. Then, another attempt to access a time slot is made after a random time interval.

The method ensures the required quality of service and guarantees a fair distribution of the channel capacity to the services.

1. A method for controlling multiple access by transmission units to a network, for time division multiplexed data transmission within cyclically arranged time slots, comprising the following steps:
determining by a plurality of contending transmission units during a time slot within ore cycle that the corresponding time slot of the following cycle will be available or data transmission,
comparing priority values by the contending transmission units within the corresponding time slot of the following cycle, wherein that one of the contending transmission units which has the highest priority wins the contention, and
reserving the corresponding time slot of a Further following cycle for data transmission by the winning transmission unit.

2. A method according to claim 1 wherein said priority values are calculated depending on the type, the amount and/or the wait time of data to be transmitted by the contending transmission units.

3. A method according to claim 2, wherein the priority values distinguish whether data to be transmitted belong to switch signals, real time connections or data transfer services.

4. A method according to claim 3, wherein said switch signals have priority over real time connections and these have priority over data transfer services, wherein data transfer services receive different priority depending on the amount of data and/or the wait time of he respective transmission unit.

5. A method according to claim 1, wherein a value (WS) is determined to indicate the amount of data to be transmitted by a transmission unit and/or the wait time of the transmission unit with the data ready to transmit, and said transmission unit accesses he network for reservation of a further time slot in addition to a time slot already reserved when said value (WS) exceeds a predetermined threshold (WSₘₐₓ).

6. A method according to claim 5, wherein a transmission unit having made reservation for a plurality of time slots releases one of the reserved time slots when said value (WS) lowers beyond a predetermined other threshold value (WSₘᵢₙ).

7. A method according to claim 1, wherein, in case of colliding date transmissions by two transmission units within one time slot, said transmissions are interrupted to release said one time slot by both transmission units and are resumed each after a random time delay.

8. A method according to claim 1, wherein data transfer services to reserve a time slot for only a limited number of cycles and, thereafter, they can renew the reservation of said time slot only if not all other time slots are occupied.

9. A method according to claim 1, wherein a real time service reserves a time slot for an unlimited number of cycles.

10. A method according to claim 1, wherein reservations of time slots are made by the transmission units themselves without central control.

11. A method according to claim 1, wherein a transmission unit which ends data transmission in a time slot indicates a release of the time slot together with the last data transmission therein.

12. A method for multiple access by transmission units to a network, for data transmission by time division multiplex within cyclically arranged time slots, wherein
a transmission unit having reserved a time slot determines a value (WS) depending on the amount of data it has to transmit and/or depending on the wait time of the data for transmission, and if said valse (WS) exceeds a predetermined threshold valve (WSₘₐₓ), said transmission unit accesses the network for reservation of a further time slot, and
a transmission unit having more than one time slot reserved releases one of said reserved time slots when said value (WS) falls below another predetermined threshold value (WSₘᵢₙ).

13. A method for multiple access by transmission units to a network, for data transmission by time division multiplex within cyclically arranged time slots, wherein
in case of colliding data transmissions by two transmission units within one time slot, said time slot is released by both transmission units and another access by each transmission unit to the network is made only after a random time delay.
